(19) United States
(12) Patent Application Publication
(10) Pub. No.: US 2019/0306557 A1
(43) Pub. Date: Oct. 3, 2019

(54) In-vehicle Listener and Viewer Data Capture System (LVDCS) and Method

(71) Applicants: Jeff Miller, Mason, OH (US); Doug Miller, Franklin, MI (US)

(72) Inventors: Jeff Miller, Mason, OH (US); Doug Miller, Franklin, MI (US)

(21) Appl. No.: 15/680,279

(22) Filed: Aug. 18, 2017

(51) Int. Cl. H04N 21/414; H04N 21/61; H04N 21/45; H04N 21/2187; H04N 21/442

(52) U.S. Cl. CPC H04N 21/41422; H04N 21/6181; H04N 21/44245; H04N 21/2187; H04N 21/4524

(57) ABSTRACT

An improved system and method of capturing, transmitting, rating (exclusive content), continuously playing, selling and advertising listener and/or viewer data from vehicle Original Equipment Manufacturers (OEM) equipped infotainment systems capable of receiving and translating live broadcasts for Analog TV, Digital TV, HDTV, Satellite TV, Satellite Radio (SIRUS/XM), AM, FM, HD, DRM, UHF, VHF, Shortwave, Internet Podcasts and Bluetooth coupled media is described herein. The In-vehicle Listener and Viewer Data Capture System (LVDCS) is capable of recording, collecting and transmitting audience measurement data (from automobiles or other vehicles), using only the vehicle's OEM equipped communication network, including viewing and listening data for all audio and video content derived from the Infotainment System Module (ISM), Audio/Video Control Module (A/VCM), touchscreen or vehicle radio. The scope of viewing and listening data collected as well as communication method are unique to the LVDCS.

Additional unique features of the LVDCS are In-Vehicle Listener and Viewer Continuous Play Feature function and Radio Data System (RDS) Interactive Bubble Advertising. The In-Vehicle Listener and Viewer Continuous Play Feature is a Method of continuously playing an Over The Air (OTA) transmission including Analog TV, Digital TV, HDTV, AM, FM, HD, DRM, UHF, VHF and Shortwave broadcast, by transitioning to the live internet broadcast stream, via either a processor or LVDCS software equipped on the vehicles Gateway Module (GWM), ISM or A/VCM, when the strength of the OTA signal drops below a pre-defined value, the internet stream will transition to that station. Conversely, when the OTA signal reaches a pre-defined value, separate and greater than the value of the transition from the OTA signal to the internet stream, the converse transition from internet stream to OTA will take place.

RDS Interactive Bubble Advertising is a Method of Advertising onto an ISM, A/VCM, touchscreen or vehicle radio by overlaying RDS Radio Text (RT) data, transmitted Over-The-Air (OTA), included in the LVDCS for interactive display. RDS data specific to advertising segments, or in between broadcast segments, transmitted OTA and received by an ISM, A/VCM, touchscreen or vehicle radio onboard vehicle touchscreen or vehicle radio will be read and processed via an onboard processor and the LVDCS to execute protocols to display Interactive Bubble Advertising. Visual display includes interactive location map, logo, symbol, emoji or hyperlinked media.

RDS RT data triggers the start and stop of the Interactive Bubble Advertising by transmitting an encoded identifying bit to authenticate the transmission. Encoded identifying bit is read and processed via the onboard processor or pre-loaded software or firmware downloaded onto an ISM, A/VCM, touchscreen or vehicle radio. Post authentication of the OTA RDS RT transmitted identifying bit, Interactive Bubble Advertising will begin. Interactive Bubble Advertising will then be used to display Advertiser content. Advertiser content will be coupled with display interface with the LVDCS for use on the ISM, A/VCM, touchscreen or vehicle radio, including interactive map displays, blue tooth enabled synchronization of dialing a displayed number or hyperlinking web based content.

### BACKGROUND

A large majority of vehicle occupants listen to audio or video media content while driving in their vehicle. While AM and FM radio waves have been equipped on vehicles for many years, in-vehicle listener and viewer metric services have not been able to utilize vehicle Original Equipment Manufacturer (OEM) equipment to capture live broadcasting listening and viewing habits, without the use of a secondary device. Software specifically developed for in-dash vehicle touchscreens, Infotainment System Modules (ISM), Audio/Video Control Modules (A/VCM), touchscreens or vehicle radios have not been developed to collect listener or viewer metrics.

Current software for Listening and Viewing Data Capture Systems (LVDCS) are not designed for mobile in-vehicle OEM communication networks. Omitted from current designs are in-vehicle LVDCS that interface with OEM communication networks that operate on multiple high, medium or low speed network channels that pass through a translation or gateway module to interpret signals produced from multiple OEM modules. Existing LVDCS lack the information structure to communicate across OEM communication networks, and therefore are not able to capture and transmit in-vehicle listener and/or viewer measurements using OEM installed modules and antenna. External sensors or URL requests for specific web searches exist, however these methods are limited in the collection of user data. Neither of these methods are practical when driving a vehicle, and a strong potential exists for the driver to be distracted from using these either of these methods. Therefore, existing LVDCS systems lack practical and safe ways to gather quantitative audience listener metrics.

Additionally, over the air (OTA) broadcasts, over existing LVDCS systems, lose reception as LVDCS units move further away from the stations transmitter. While a large majority of vehicle occupants listen to audio or video media content while driving their truck or vehicle, driving long distances at highway speeds often is a major cause for loss of signal. When disruptions to media content occur, occupants can become frustrated, leading to elevated blood pressure or other body stressors.

No device exists that can utilize both OTA and internet broadcast streams to maintain continuous, non-disrupted media streams. Current OTA transmissions slowly drop out as the distance away from the media's transmitter increases, with no ability to continuously stream the content. With a vast majority of TV and Radio stations having a live streaming internet broadcast, the link between the OTA signal and internet stream does not exist.

Existing LVDCS systems provide advertisements to users with a very limited capability. Current Radio Data System (RDS) text advertisements are limited to non-interactive text displays, primarily on in-vehicle media players. Despite the OEM hardware and communication networks already installed on modern vehicles, RDS data has not been integrated into a vehicle or other receiving device for full use of interactive advertising. While RDS Radio Text (RT) is capable of outputting 64 text characters, these characters are not being utilized to integrate on-line advertising into an Infotainment System Module (ISM), Audio/Video Control Module (A/VCM), touchscreen or vehicle radio.

This disclosure relates to an In-vehicle LVDCS comprised of software, hardware and a communication network which captures metrics for live broadcasts for Analog Television (TV), Digital TV, High Definition TV (HDTV), Satellite TV, Satellite Radio (SIRIUS/XM), AM, FM, HD, Digital Radio Transmission (DRM), Shortwave, Internet Podcasts and Bluetooth coupled media.

This disclosure also relates to an In-Vehicle Listener and Viewer Continuous Play Feature, which is a method of continuously streaming an Over The Air (OTA) transmission including Analog TV, Digital TV, HDTV, AM, FM, HD, DRM and Shortwave broadcast, by transitioning to the live internet broadcast stream, via either a processor or LVDCS software equipped on the vehicles Gateway Module, ISM or A/VCM. The disclosure also relates to a method of continuously playing a broadcast by transitioning between an Over-the-Air (OTA) Analog TV, Digital TV, HDTV, AM, FM, HD, DRM or Shortwave broadcast transmission to a live streaming transmission, via firmware or software equipped on the vehicles Gateway Module, Infotainment System Module (ISM), Audio/Video Control Module (A/VCM), onboard vehicle touchscreen, or vehicle radio. Utilizing an internet enabled vehicle and its pre-existing OEM supplied infrastructure and communication links, the In-vehicle Listener and Viewer Continuous Play Feature will allow a vehicle occupant to continue to stream their media content without interruption. When the strength of the OTA signal drops below a pre-defined value, the internet stream will transition to that station. No such device exists that can utilize both OTA and internet broadcast streams to maintain continuous, non-disrupted media streams. Current OTA transmissions slowly drop out as the distance away from the media's transmitter increases, with no ability to continuously stream the content. Despite a vast majority of TV and Radio stations also having a live streaming internet broadcast, the link between the OTA signal and the internet stream does not exist.

This disclosure also relates to a RDS Interactive Bubble Advertising feature, which is a method of advertising onto an ISM, A/VCM, touchscreen or vehicle radio by processing RDS data, transmitted OTA, included in the LVDCS for interactive display. This disclosure also relates to an LVDCS translating an OTA RDS data into an advertisement. OTA RDS broadcast transmissions are used throughout the world to display information on Clock Time (CT), Program Identification (PI), Program Service (PS), Program Type (PT), Region (REG), Radio Text (RT), Traffic Announcements (TA), and so forth. LVDCS software recognizes the RDS Text and sets exceptionable events around those character values. Using all OEM hardware equipment and communication links, already installed on the vehicle, the OTA RDS data is translated via software pre-loaded onto the ISM, A/VCM, onboard vehicle touchscreen or vehicle radio for a visual Interactive Bubble Advertising display. Current RDS text advertisements are limited to non-interactive text displays. With the OEM hardware and communication networks already installed on modern vehicles, RDS data has not been integrated into a vehicle or other receiving device for full use of interactive advertising. While RDS RT is capable of outputting 64 characters, these characters are not being utilized to integrate on-line advertising into an ISM, A/VCM, on-board vehicle touchscreen or vehicle radio. No other method exists that integrates the communication networks capable of integrating RDS RT into Interactive Bubble Advertising.

This disclosure also relates to a MYRating Software feature, whereby exclusive media content is streamed using the LVDCS communication network and allows users to rate the content by using a quantitative five star rating method. LVDCS is required for implementing MYRating, however MYRating is not required for LVDCS and is an option. This disclosure also relates to an interactive, in-vehicle, LVDCS that uses pre-existing OEM equipped hardware and introduces software to collect listener and/or viewer measurement data and audience ratings using an Infotainment System Module (IS), Audio/Video Control Module (A/VCM), onboard vehicle touchscreen, or vehicle radio. The in-vehicle LVDCS and unique MYRating software will safely collect audio and video data, using a touchscreen or in-vehicle radio equipped in a motorized vehicle, and will also compile user defined ratings for a wide variety of media content. The in-vehicle LVDCS utilizes OEM equipment and communication networks, already equipped in the vehicle, to collect the audience measurement data. Previous attempts to record media audience measurement data has been limited to non-vehicles and have required either a peripheral device for Over-The-Air (OTA) and Satellite content or internet connectivity for on-line content, neither of which is required to collect listener and viewer measurement data using the in-vehicle LVCDS.

This disclosure also relates to a method for advertising sponsored content using pre-loaded Interactive Bubble Advertising Software, not received from an external transmission. Pre-loaded software recognizes the RDS RT and sets exceptionable events around those character values. No other method exists that integrates the communication networks capable of integrating RDS RT into Interactive Bubble Advertising. The same pre-loaded Interactive Bubble Advertising Software can be used to, independent of transmission, display advertisements based on the media content loaded into the In-vehicle Listener and Viewer Data Capture System (LVDCS).

This disclosure also relates to a method for determining, collecting, and transmitting individual vehicle signal strength data transmitted. Current OTA audio/video signals require a software meter. Software meters are peripheral devices such as a set top box, Digital Video Recorder, Media Server or a computing device linked to the internet. Existing software is not equipped to send and receive listening and viewing metrics, using only vehicle OEM hardware.

### SUMMARY

The following is a brief summary of subject matter that is described in greater detail herein. This summary is not intended to be limiting as to the scope of the claims.

The in-vehicle LVDCS and unique LVDCS software will safely collect audio and video data, using a touchscreen or in-vehicle radio equipped in a motorized vehicle, and will also compile user defined ratings for a wide variety of media content. The in-vehicle LVDCS utilizes OEM equipment and communication networks, already equipped in the vehicle, to collect the audience measurement data. Previous attempts to record media audience measurement data has been limited to non-vehicles and have required either a peripheral device for OTA and Satellite content or internet connectivity for on-line content, neither of which is required to collect listener and viewer measurement data using the in-vehicle LVDCS.

Included in the LVDCS software is the In-vehicle Listener and Viewer Continuous Play Feature; a method that links OTA signals to internet streaming broadcasts for a continued listening experience, regardless of geographic location. Utilizing an internet enabled vehicle and its pre-existing OEM supplied infrastructure and communication links, the In-vehicle Listener and Viewer Continuous Play Feature will allow vehicle occupant to continue to stream their media content without interruption. By determining the strength of the broadcast transmission, the In-vehicle Listener and Viewer Continuous Play Feature will compare live signal strength readings to that of pre-set numerical values that will execute one of four functions for OTA Analog TV, Digital TV, HDTV, AM, FM, HD, DRM and Shortwave broadcast transmissions: 1) Internet broadcast background start-up protocol, 2) Internet broadcast begin, 3) Internet broadcast terminate, and 4) OTA Transmission broadcast

Interactive Bubble Advertising is a method to display interactive advertisements, map out advertised locations, display phone numbers for single touch dialing, display advertised symbols, emojis or generate a hyperlink to internet enabled content on an ISM, A/VCM, touchscreen or vehicle radio by receiving RDS RT transmitted OTA and processing that text into an advertisement using the LVDCS.

This disclosure relates to an interactive, in-vehicle LVDCS that uses pre-existing OEM equipped hardware and introduces software to collect listener and/or viewer measurement data as well as recording audience ratings using an ISM, A/VCM, touchscreen or vehicle radio.

Additional disclosure included with the LVDCS is a method of continuously playing an OTA Analog TV, Digital TV, HDTV, AM, FM, HD, DRM and Shortwave broadcast transmission by transitioning to a live streaming transmission, utilizing an internet enabled vehicle and its pre-existing OEM supplied infrastructure and communication links, the In-vehicle Listener and Viewer Continuous Play Feature will allow vehicle occupant to continue to stream their media content without interruption.

Additional disclosure relates to a method for receiving RDS RT data for advertising of sponsored content transmitted OTA and displaying that content into an interactive display on an ISM, A/VCM, touchscreen or vehicle radio. Using all OEM hardware equipment and communication links, already installed on the vehicle, the OTA RDS RT data is translated via the LVDCS software pre-loaded onto the ISM, A/VCM, touchscreen or vehicle radio for a visual Interactive Bubble Advertising display.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary system that facilitates In-Vehicle Communication Network for Data Transmission determining, collecting, and transmitting individual vehicle signal strength data transmitted.

FIG. 2 is mockup of an Infotainment System AM/FM Display onto the infotainment system module, audio/video control module, on-board vehicle touchscreen or vehicle radio.

FIG. 3 is mockup of an Infotainment System HD Display onto the infotainment system module, audio/video control module, on-board vehicle touchscreen or vehicle radio.

FIG. 4 is mockup of an Infotainment System SIRIUS XM Display onto the infotainment system module, audio/video control module, on-board vehicle touchscreen or vehicle radio.

FIG. 5 is mockup of an Infotainment System Short Wave Display onto the infotainment system module, audio/video control module, on-board vehicle touchscreen or vehicle radio.

FIG. 6 is mockup of an Infotainment System DRM Display onto the infotainment system module, audio/video control module, on-board vehicle touchscreen or vehicle radio.

FIG. 7 is a mockup of an Infotainment System LVDCS software MYRating Display onto the infotainment system module, audio/video control module, on-board vehicle touchscreen or vehicle radio.

FIG. 8 is a functional block diagram of an exemplary system that facilitates determining, collecting, and transmitting individual vehicle signal strength data transmitted.

FIG. 9. is a table illustrating Individual Vehicle Signal Strength Data Transmitted

FIG. 10 is a table illustrating a Cloud Server Compressed Signal Strength Data File

FIG. 11 is a functional block diagram of an exemplary system that facilitates an In-vehicle Listener and Viewer Continuous Play Feature

FIG. 12 is a diagram illustrating an OTA to internet stream transition.

FIG. 13 is a flow diagram that illustrates an exemplary methodology for an OTA to internet stream transition.

FIG. 14 is a flow diagram that illustrates an exemplary methodology for an internet stream to OTA transition.

FIG. 15 is a functional block diagram of an exemplary system that facilitates the Interactive Bubble Advertising feature.

FIG. 16 is a table illustrating the use of an RDS Radio Text string for the Interactive Bubble Advertising system.

FIG. 17 is a mockup of the Interactive Bubble Advertising system displaying the advertised location onto the infotainment system module, audio/video control module, on-board vehicle touchscreen or vehicle radio.

FIG. 18 is a mockup of the Interactive Bubble Advertising system displaying a Symbol or Logo onto the infotainment system module, audio/video control module, on-board vehicle touchscreen or vehicle radio.

FIG. 19 is a mockup of the Interactive Bubble Advertising system displaying and capable of single touch dialing the advertised phone number appearing onto the infotainment system module, audio/video control module, on-board vehicle touchscreen or vehicle radio.

FIG. 20 is a mockup of the Interactive Bubble Advertising system displaying advertised content generated from a pre-defined URL.

FIG. 21 is a mockup of the Interactive Bubble Advertising system displaying an emoji.

FIG. 22 is a mockup of the Interactive Bubble Advertising system displaying and capable of playing a video generated from a pre-defined URL.

FIG. 23 is a functional block diagram that illustrates the LVDCS in a computing embodiment.

### DETAILED DESCRIPTION

Various technologies pertaining to an in-vehicle Listener and Viewer Data Capture System (LVDCS) are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Additionally, as used herein, the term “exemplary” is intended to mean serving as an illustration or example of something, and is not intended to indicate a preference.

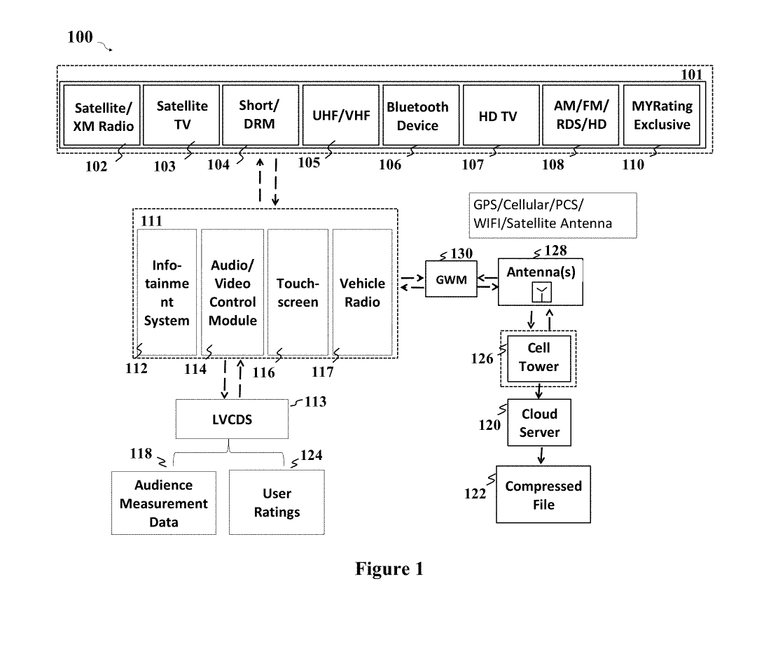

With reference to FIG. 1, an exemplary system 100 that facilitates an In-Vehicle communication network for data transmission is illustrated. The network 100 includes a plurality of input signals 101. The input signal 101, in an exemplary example, is an OTA broadcast signal, including a Satellite/XM Radio 102, Satellite TV 103, Shortwave/DRM 104, UHF/VHF 105, Bluetooth Device 106, HD TV 107, AM/FM/RDS/HD Radio 108 and MYRating Exclusive 110 content that is regularly broadcast over airways transmitted via a licensed station's transmitter, satellite, internet, or independent device. The MYRating Exclusive 110 provides recommended content based on the user ratings 124. The network 111 includes an infotainment system 112, audio/video control module 114, touchscreen 116 and vehicle radio 117. In one exemplary embodiment, the infotainment system module 112 is an infotainment system video control module. The infotainment system module 112 has two functions: an in-dash touchscreen input to select from one of the input signals, and an audio and video control function. In one embodiment, an audio and video control module 114 is a separate function from the infotainment system 112: in other words, the infotainment system 112 represents an in-dash touchscreen input only. The network includes an in-vehicle Listener and Viewer Data Capture System (LVDCS) firmware or software 113, the LVDCS firmware or software 113 residing in the infotainment system 112. The network 100 also includes audience measurement data 118, a cloud based server 120, a compressed audience measurement file 122, user ratings 124, a cell tower 126, antenna 128, the antenna 128 being a Global Positioning System (GPS) module, or a Wi-Fi antenna, and a gateway module (GWM) 130. The MYRating Exclusive 110 provides recommended content based on the user ratings 124.

The LVDCS firmware or software 113 reads the input signal 101 from network 111. The LVDCS software 113 then sends user data, via an antenna 128 to a cell tower 126 or directly to a cloud based server 120. The cloud based server 120 could be one server or multiple servers performing distributed functions. User data will be transmitted, at pre-defined time intervals, to the cloud based server 120 via the OEM equipped Satellite, GPS, Cellular, PCS or the antenna 128. In one exemplary embodiment, the antenna 128 is a Wi-Fi antenna. No additional external equipment will be needed to read viewer or listener measurements. However, vehicles not originally equipped with the proper equipment will not be able to receive signals for a select media offering. The cloud based server 120 will compile all the user data and compress the user data into the single compressed audience measurement file 122 for data mining. The LVDCS software 113 will collect and compile the audience measurement file 118 and the user rating 124. The LVDCS software 113 will then facilitate data transmission content of the audience measurement file 118 and the user rating 124 to the cloud based server 120.

In an exemplary example, the audience measurement file 118 includes user demographic data such as age and sex, program information as displayed by the infotainment system module 112 or the audio/video control module 114, time duration of listening or viewing of program and GPS location of vehicle position, and the MYRating 110 user defined five-star rating for exclusive MYRating content. Audience measurement file 118 includes, but is not limited to, time duration of listening or viewing of the program station, GPS location of vehicle, reception strength of the signal, given the GPS location, user profile data including age and sex, and vehicle make, model and model year. The user rating 124 is a pass-through of the user defined five star ratings for MYRating exclusive 110 input.

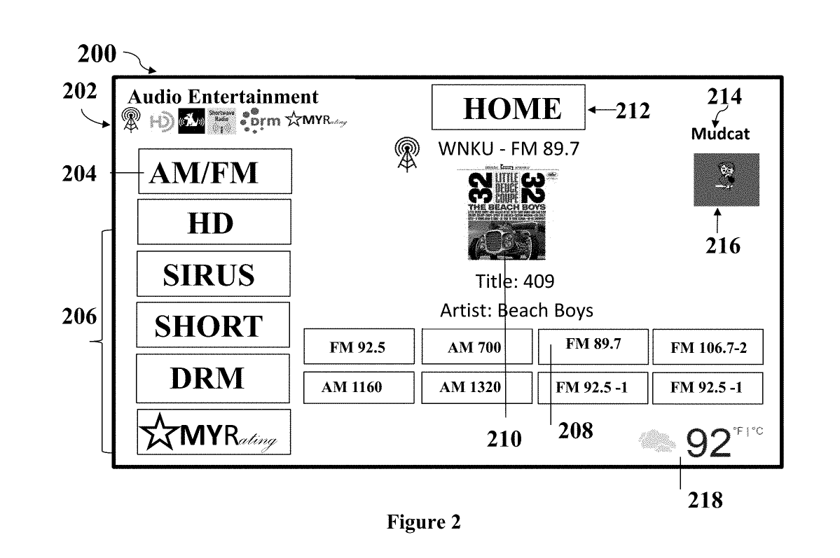

Referring now to FIG. 2, a mockup of an infotainment system for an AM/FM display 200 is illustrated. The AM/FM display 200 is comprised of an audio entertainment dashboard 202, a set of audio outputs 206, a user-selected AM/FM audio output 204, a user-selected preset selection 208, and an informational display 210. The audio entertainment dashboard 202 displays the set of available, selectable set audio outputs 206. The user-selected AM/FM audio output 204, when selected, will be displayed in a gradient different from the other set of audio outputs 206, in order to provide the user with positive visual feedback of a successful selection of the user-selected AM/FM audio output 204. The user-selected preset selection 208 will be displayed in a gradient different from other presets on the screen, in order to provide the user with positive visual feedback of a successful selection. The informational display 210, in an exemplary example, would show a corresponding icon from the audio entertainment dashboard 202, a text display of the user-selected preset selection 208, a text display of the artist being played, a text display of the corresponding album title, and a picture or icon of the corresponding album. The AM/FM display 200, in an exemplary example, also displays a home button 212 to bring the user back to the home display, a username 214 and customizable user icon 216, and a weather display 218 with the temperature and visual icon of the local weather conditions.

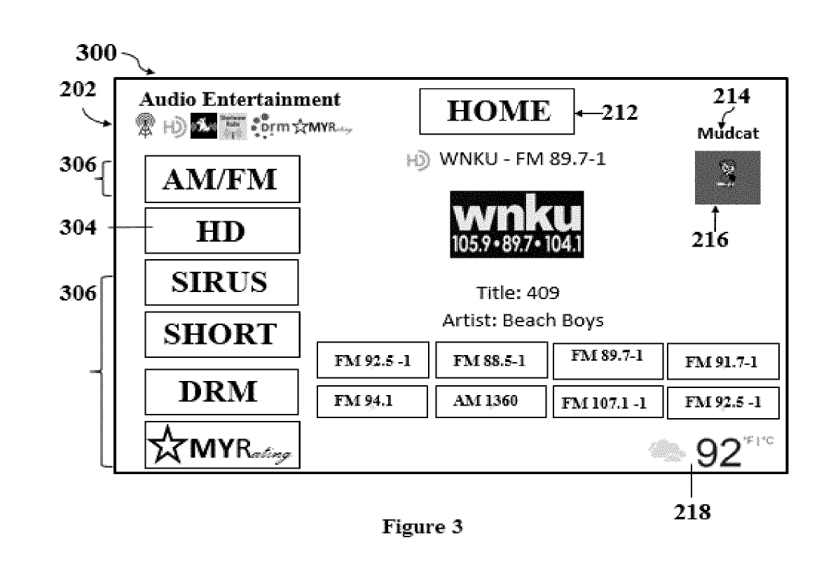

Referring now to FIG. 3, a mockup of an infotainment system for an HD display 300 is illustrated. The HD display 300 is comprised of an audio entertainment dashboard 302, a set of audio outputs 306, a user-selected HD audio output 304, a user-selected preset selection 308, and an informational display 310. The audio entertainment dashboard 302 displays the set of available, selectable set audio outputs 306. The user-selected HD audio output 304, when selected, will be displayed in a gradient different from the other set of audio outputs 306, in order to provide the user with positive visual feedback of a successful selection of the user-selected HD audio output 304. The user-selected preset selection 308 will be displayed in a gradient different from other presets on the screen, in order to provide the user with positive visual feedback of a successful selection. The informational display 310, in an exemplary example, would show a corresponding icon from the audio entertainment dashboard 202, a text display of the user-selected preset selection 308, a text display of the artist being played 312, a text display of the corresponding song title 314, and a picture or icon of the corresponding album 316. The HD display 300, in an exemplary example, also displays a home button 212 to bring the user back to the home display, a username 214 and customizable user icon 216, and a weather display 218 with the temperature and visual icon of the local weather conditions.

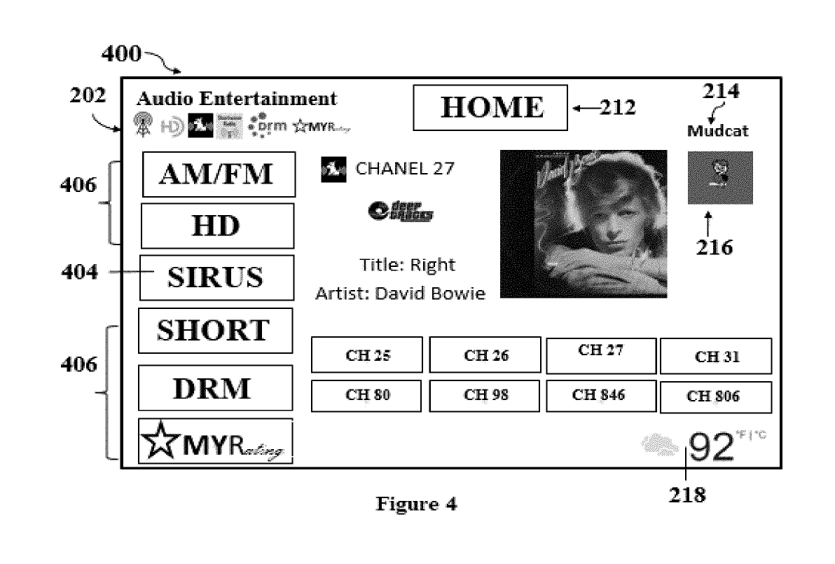

Referring now to FIG. 4, a mockup of an infotainment system for a Sirius/XM (satellite radio) display 400 is illustrated. The Sirius/XM display 400 is comprised of an audio entertainment dashboard 202, a set of audio outputs 406, a user-selected Sirius/XM audio output 404, a user-selected preset selection 408, and an informational display 410. The audio entertainment dashboard 202 displays the set of available, selectable set audio outputs 406. The user-selected Sirius/XM audio output 404, when selected, will be displayed in a gradient different from the other set of audio outputs 406, in order to provide the user with positive visual feedback of a successful selection of the user-selected Sirius/XM audio output 404. The user-selected preset selection 408 will be displayed in a gradient different from other presets on the screen, in order to provide the user with positive visual feedback of a successful selection. The informational display 410, in an exemplary example, would show a corresponding icon from the audio entertainment dashboard 202, a text display of the user-selected preset selection 408, a text display of the artist being played 412, a text display of the corresponding song title 414, and a picture or icon of the corresponding album 416. The Sirius/XM display 400, in an exemplary example, also displays a home button 212 to bring the user back to the home display, a username 214 and customizable user icon 216, and a weather display 218 with the temperature and visual icon of the local weather conditions.

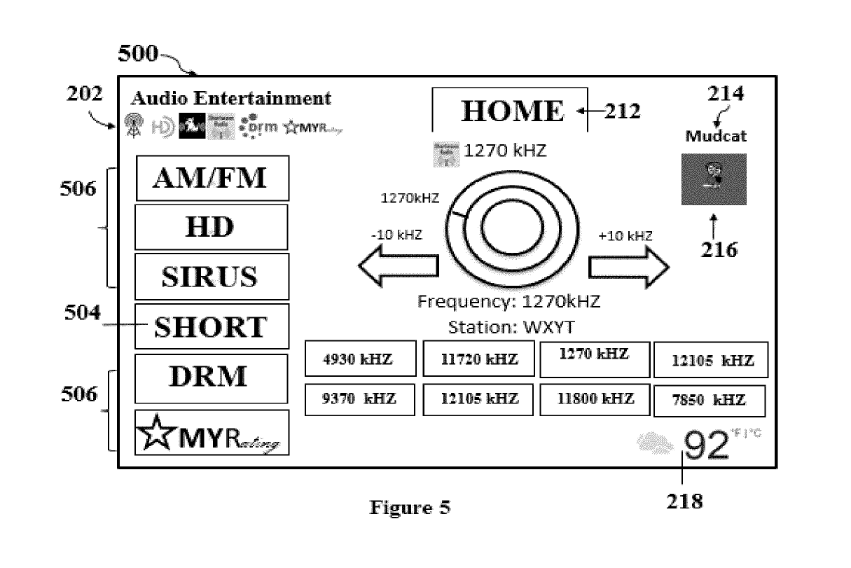

Referring now to FIG. 5, a mockup of an infotainment system for a shortwave display 500 is illustrated. The shortwave display 500 is comprised of an audio entertainment dashboard 202, a set of audio outputs 506, a user-selected shortwave audio output 504, a user-selected preset selection 508, and an informational display 510. The audio entertainment dashboard 202 displays the set of available, selectable set audio outputs 506. The user-selected shortwave audio output 504, when selected, will be displayed in a gradient different from the other set of audio outputs 506, in order to provide the user with positive visual feedback of a successful selection of the user-selected shortwave audio output 504. The user-selected preset selection 508 will be displayed in a gradient different from other presets on the screen, in order to provide the user with positive visual feedback of a successful selection. The informational display 510, in an exemplary example, would show a corresponding icon from the audio entertainment dashboard 202, a text display of the user-selected preset selection 508, a text display of the frequency station call letters 510, and a display of the shortwave frequency 512 with a manual tuning feature of the shortwave frequency in +10 kHz and −10 kHz increments. The shortwave display 500, in an exemplary example, also displays a home button 212 to bring the user back to the home display, a username 214 and customizable user icon 216, and a weather display 218 with the temperature and visual icon of the local weather conditions.

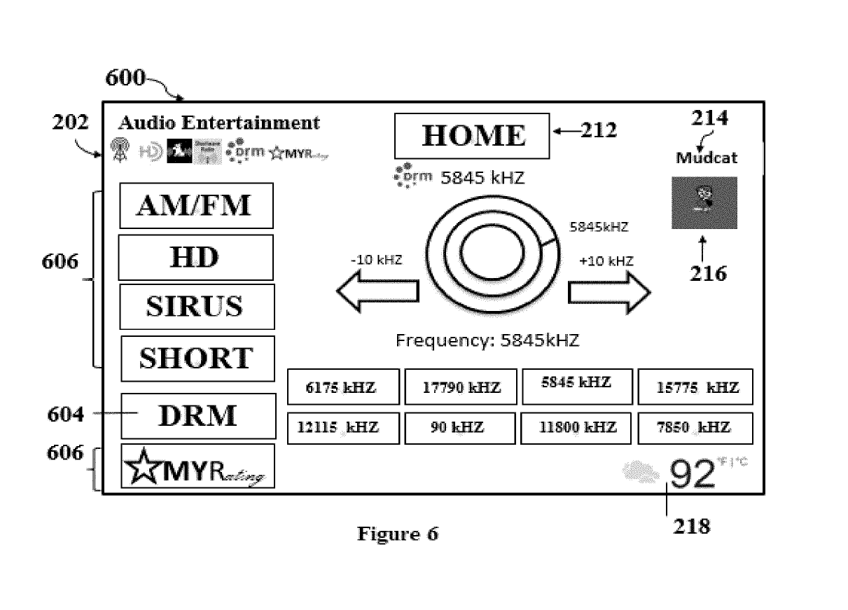

Referring now to FIG. 6, a mockup of an infotainment system for a DRM display 600 is illustrated. The DRM display 600 is comprised of an audio entertainment dashboard 202, a set of audio outputs 606, a user-selected DRM audio output 604, a user-selected preset selection 608, and an informational display 610. The audio entertainment dashboard 202 displays the set of available, selectable set audio outputs 606. The user-selected DRM audio output 604, when selected, will be displayed in a gradient different from the other set of audio outputs 606, in order to provide the user with positive visual feedback of a successful selection of the user-selected DRM audio output 604. The user-selected preset selection 608 will be displayed in a gradient different from other presets on the screen, in order to provide the user with positive visual feedback of a successful selection. The informational display 610, in an exemplary example, would show a corresponding icon from the audio entertainment dashboard 202, a text display of the user-selected preset selection 608, a text display of the frequency station call letters, and a display of the DRM frequency with a manual tuning feature of the shortwave frequency in +10 kHz and −10 kHz increments. The DRM display 600, in an exemplary example, also displays a home button 212 to bring the user back to the home display, a username 214 and customizable user icon 216, and a weather display 218 with the temperature and visual icon of the local weather conditions.

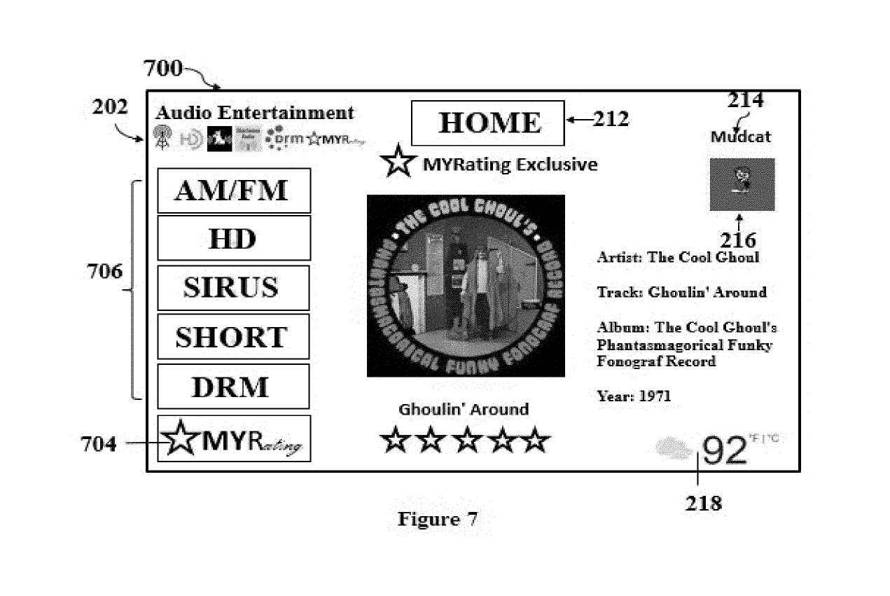

Referring now to FIG. 7, a mockup of an infotainment system for a MYRating Interactive display 700 is illustrated. The MYRating display 700 is comprised of an audio entertainment dashboard 202, a set of audio inputs 706, a user-selected MYRating audio input 704, a MYRating user rating selection 708, and an informational display 710. The audio entertainment dashboard 202 displays the set of available, selectable set audio inputs 706. The user-selected MYRating audio input 704, when selected, will be displayed in a gradient different from the other set of audio inputs 706, in order to provide the user with positive visual feedback of a successful selection of the user-selected MYRating audio input 704. The MYRating user rating selection 708 will be displayed in a five star horizontal configuration, where each star will have a yellow outline and no fill. When the user wishes to rate the MYRating user rating selection 708, the user taps the corresponding star position to rate the MYRating user rating selection 708. In an exemplary example, FIG. 7 shows MYRating user rating selection 708 of four stars. The informational display 710, in an exemplary example, would show a corresponding icon from the audio entertainment dashboard 702, a text display of the artist being played, a text display of the corresponding album title, and a picture or icon of the corresponding album. The MYRating Interactive display 700, in an exemplary example, also displays a home button to bring the user back to the home display, a username 214 and customizable user icon 216, and a weather display 218 with the temperature and visual icon of the local weather conditions.

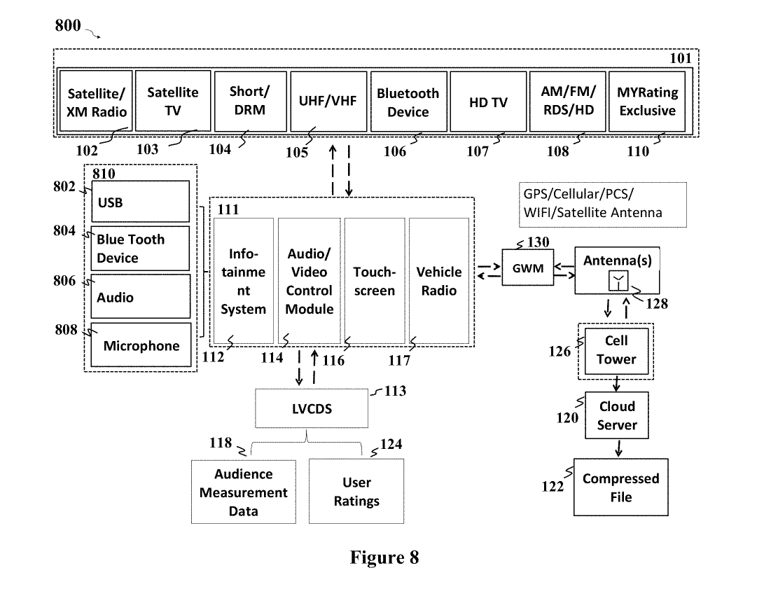

FIG. 8 is a functional block diagram of an exemplary system 800 that facilitates determining, collecting, and transmitting individual vehicle signal strength data transmitted. This LVDCS system 800 will collect information on 1) audience measurement data 118, which includes user demographic data such as Age and Sex and program information as displayed by an Infotainment System Module 112, Audio/Video Control Module 114, touchscreen 116 or vehicle radio 117, duration of listening or viewing of program and GPS location from a GWM 130 of a vehicle position and 2) a LVDCS user rating 124 for exclusive LVDCS software content. LVDCS and MYRating software will not be exclusive to a single OEM company. The infotainment system network 111 intakes an input signal from network 810, including USB bus 802, a Bluetooth device 804, an audio input jack 806, or a microphone 808. The Infotainment System Module 112, the Audio/Video Control Module 114, touchscreen 116 or vehicle radio 117 will come equipped with firmware to recognize the make, model, model year and OEM equipment installed. OEM equipment, such as the vehicle's antenna 128 and vehicle transmission networks will be utilized to read and transmit data. The LVDCS system 800 is capable of monitoring vehicles OTA reception strength. Data for OTA signal strength, from a given vehicle, can be evaluated given the GPS location generated by the GWM 130. Data collectively gathered from OTA signal strength, for a given vehicle, can be evaluated and compared to the transmission power of the OTA transmitter.

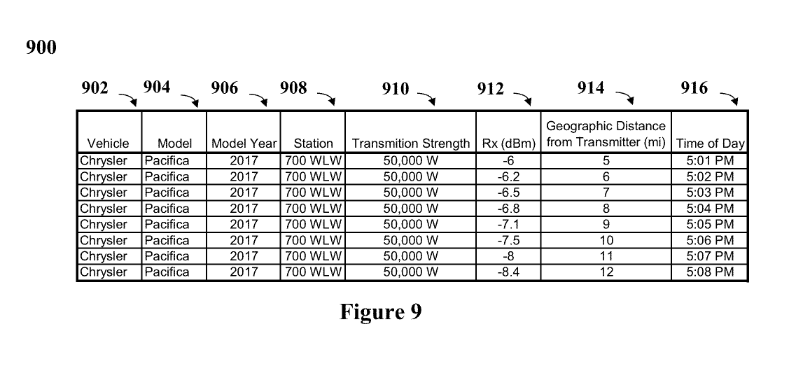

Referring now to FIG. 9, a table 900 illustrating individual vehicle signal Strength Data Transmitted in the compressed file 122 is illustrated. Two separate subsets of data will be made available for lease 1) the in-vehicle LVDCS audience measurement data 816, including information on signal strength, vehicle make and vehicle model and 2) the user defined ratings 818 from MYRating, which is defined five star rating for unique content. The in-vehicle LVDCS audience measurement data 816 is comprised of a vehicle make value 902, a vehicle model value 904, a vehicle model year value 906, a station identifier value 908, a transmission strength value 910, in a unit of watts, a receive signal strength value 912, in a unit of dBm, a vehicle geographic distance from a transmitter value 914, in a unit of miles, and a time of day value 916. Leases will be able to obtain both subsets of data, from a web-site, equipped with a program available for download.

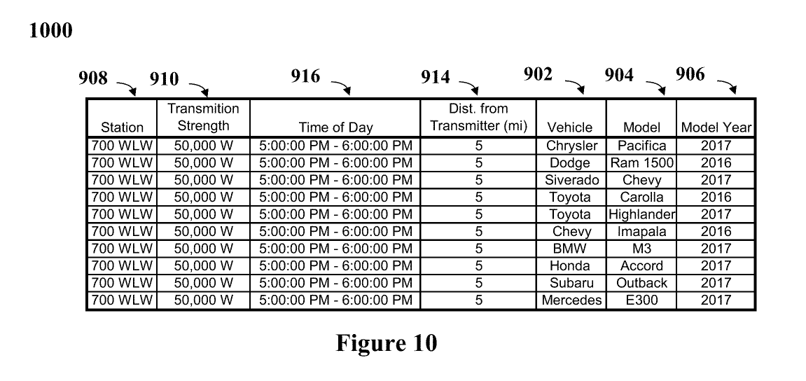

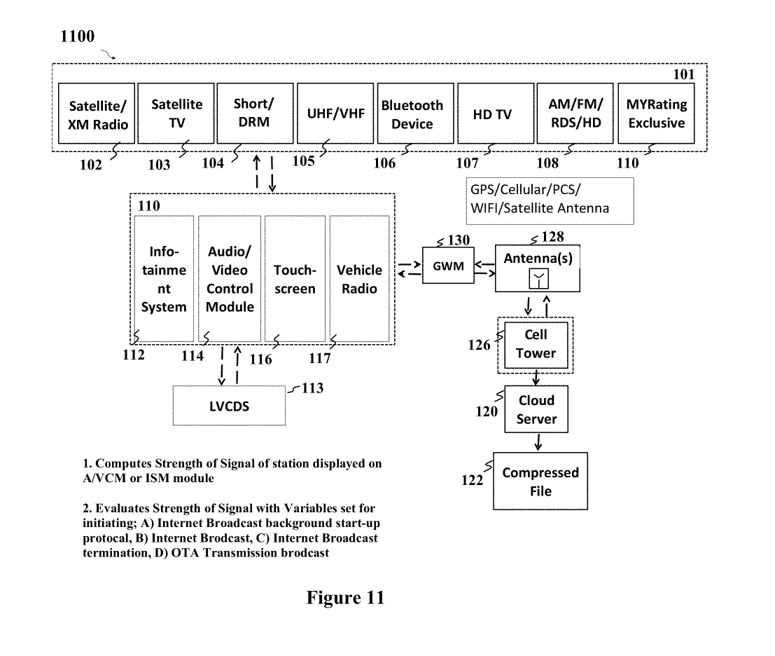

Referring now to FIG. 10, a table 1000 illustrating a Cloud Server Compressed Signal Strength Data File 122 is illustrated. The Cloud Server Compressed Signal Strength Data File 820 is comprised of a station identifier value 908, the transmission strength value 910, the time of day value 916, the vehicle geographic distance from a transmitter value 914, the vehicle make value 902, the vehicle model value 904, and the vehicle model year value 906. The Cloud Server Compressed Signal Strength Data File 122 is transmitted to a cloud server, similar to the in-vehicle LVDCS audience measurement data 118. In one exemplary example, the cloud server will also be equipped to compress the vehicle LVDCS audience measurement data 118. This compressed vehicle LVDCS audience measurement data 118 would then be sent to a mainframe server. The LVDCS or MYRating website will generate personalized data based on in-vehicle listening and/or viewing measurement system metrics contained in the Cloud Server Compressed Strength Data File 122. In one exemplary example, Age, Sex, Time of Day, Duration of time tuned into programming, GPS location, number of total users tuned-in to programming content, and five-star rating comprises these metrics.

Referring now to FIG. 11, a functional block diagram of an exemplary In-vehicle Listener and Viewer Continuous Play Feature system 1100 is illustrated. The In-vehicle Listener and Viewer Continuous Play Feature system 1100 seamlessly streams OTA broadcast transmissions, by pairing the OTA transmission with its live streaming internet broadcast counterpart, using only OEM supplied hardware and no supplemental devices. The In-vehicle Listener and Viewer Continuous Play Feature system 1100 links OTA signals to internet streaming broadcasts for a continued listening experience, regardless of geographic location. The In-vehicle Listener and Viewer Continuous Play Feature system 1100 determines the strength of the set broadcast transmission, measured in dBm, for a relative geographical location, a series of conditions that compare the given live signal strength readings to that of pre-set numerical values that correspond to set conditions will be processed via a computer processor or software equipped on the Gateway Module 130, the Infotainment System Module 112, Audio/Video Control Module 114, onboard vehicle touchscreen 116, or vehicle radio 117 allowing it to execute one of four functions for input signal 101, in an exemplary example, is an OTA broadcast signal, including a Satellite/XM Radio 102, Satellite TV 103, Shortwave/DRM 104, UHF/VHF 105, Bluetooth Device 106, HD TV 107, AM/FM/RDS/HD Radio 108 and MYRating Exclusive content 110 that is regularly broadcast over airways transmitted via a licensed station's transmitter or satellite. The LVDCS software 113 computes the signal strength of the station displayed on the Infotainment System Module (ISM) 112, Audio/Video Control Module (A/VCM) 114, touchscreen 116 or vehicle radio 117 or the. The LVDCS software 113 then evaluates the strength of signal with variables set for initiating one of five modes: an Internet broadcast background start-up protocol; “Internet Stream Identified” mode; an Internet broadcast begin mode; an Internet broadcast terminate mode; and, a return to OTA Transmission broadcast mode. Using the Communication network described in the LVDCS software 113, where the vehicle is continuously sending live OTA strength of signal readings through the antenna 128, the LVDCS 113 will execute one of the modes above to allow the user to continue enjoying the desired media transmission

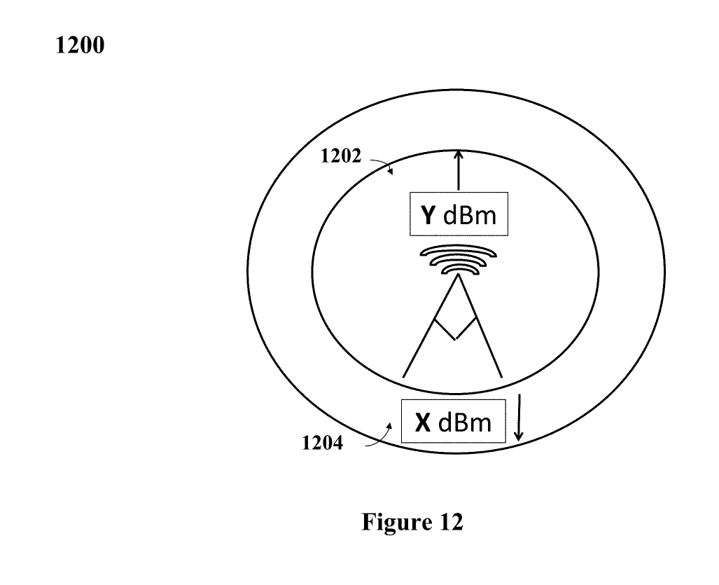

Referring now to FIG. 12, a diagram of an exemplary In-vehicle Listener and Viewer Continuous Play Feature via the OTA to internet stream transition system 1200 is illustrated. Modern vehicles translate an OTA station ID's for the Infotainment System Module 112, the Audio/Video Control Module 114, touchscreen 116 or vehicle radio 117. The In-vehicle Listener and Viewer Continuous Play Feature via the OTA to internet stream transition system 1200 also measures the strength of the OTA signal as outlined in the in-vehicle LVDCS software 113 above. With the continual measurements of OTA strength of signal being collected, these quantitative measurements will be paired to set variables: at a Y dBm level 1202, at a X dBm 1204 level and a Z dBm level 1206, where X, Y and Z are pre-set variables measured in dBm (power ratio of decibels to one milliwatt) of the measure, used to trigger a series of processes. For vehicles moving away from the OTA radio transmitter 1206 the vehicle will continue to broadcast the OTA transmission as they exceed or are equal to the Y dBm level 1202, pictured in green. When the strength of signal falls below the X dBm level 1204, pictured in yellow, the computer processor or software equipped on the vehicle Gateway Module 130, the Infotainment System Module 112, the Audio/Video Control Module 114, onboard vehicle touchscreen 116, or vehicle radio 117 will initiate a protocol to search the internet to find its internet live stream.

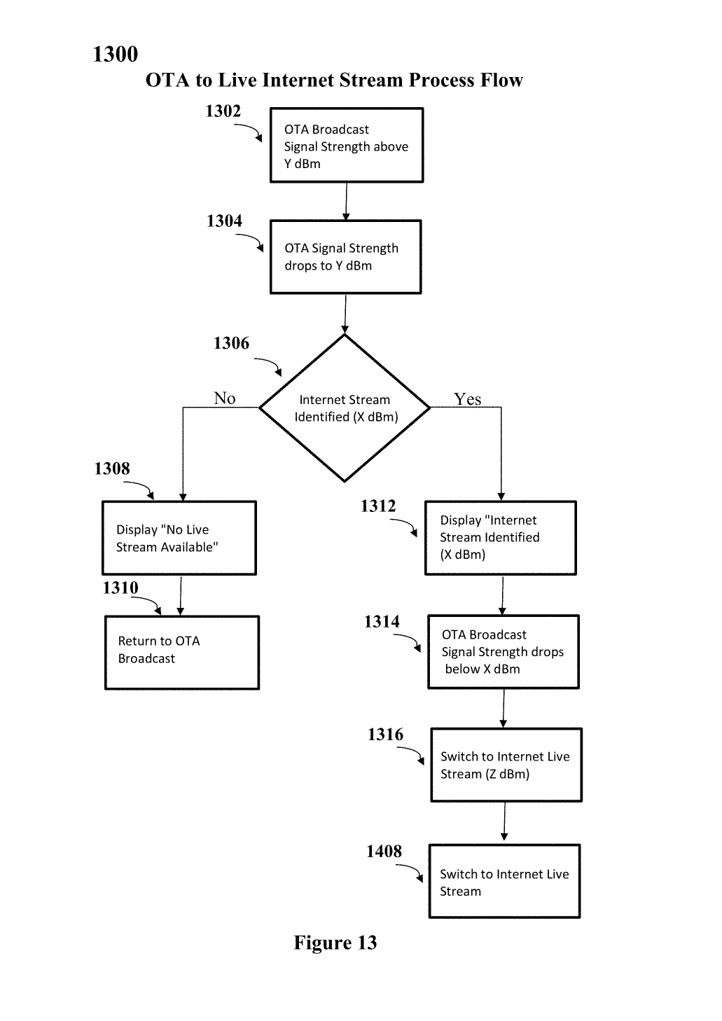

Referring now to FIG. 13, a methodology 1300 that facilitates an OTA to internet broadcast stream transition is illustrated. The methodology 1300 begins at 1302, where for vehicles moving away from the OTA transmitter the vehicles will continue to broadcast the OTA transmission as they exceed or are equal to the Y dBm level 1202. The methodology then transitions to 1304 when the strength of the signal falls below the Y dBm level 1202. The computer processor or software equipped on the vehicle Gateway Module 130, Infotainment System Module 112, the Audio/Video Control Module 114, onboard vehicle touchscreen 116, or vehicle radio 117 will initiate a protocol to search the internet to find its internet live stream. The methodology then transitions to 1306, where if no internet stream is detected after the strength of signal falls below the Y dBm level 1202 to X dBm level 1204, the methodology transitions to 1308 where the display will silently notify the user; “No Live Stream Available”. Display and processing of this condition will not cause an interruption to the OTA transmission. OTA broadcast transmission will continue playing until user chooses to end the particular broadcast transmittal, by powering down the media playing device or by finding a new broadcast transmission. Returning to methodology 1306, if the internet stream is detected after the strength of signal falls below the Y dBm level 1202 to the X dBm level 1204, the methodology transitions to 1312 where the display will silently notify the user; “Live Stream Detected”. The display and process of this condition will not cause an interruption to the OTA transmission. When the strength of signal falls below the X dBM level 1204 in methodology 1314, the switch to the internet transmission will begin in methodology 1316. As the strength of signal falls below the X dBM level 1204, the OTA radio Transmission goes on standby, until the strength of signal increases to the Y dBm level 1202 or greater. Once the strength of signal transitions back to the Y dBm level 1202, the internet stream will end and the OTA transmission will resume at the methodology 1302.

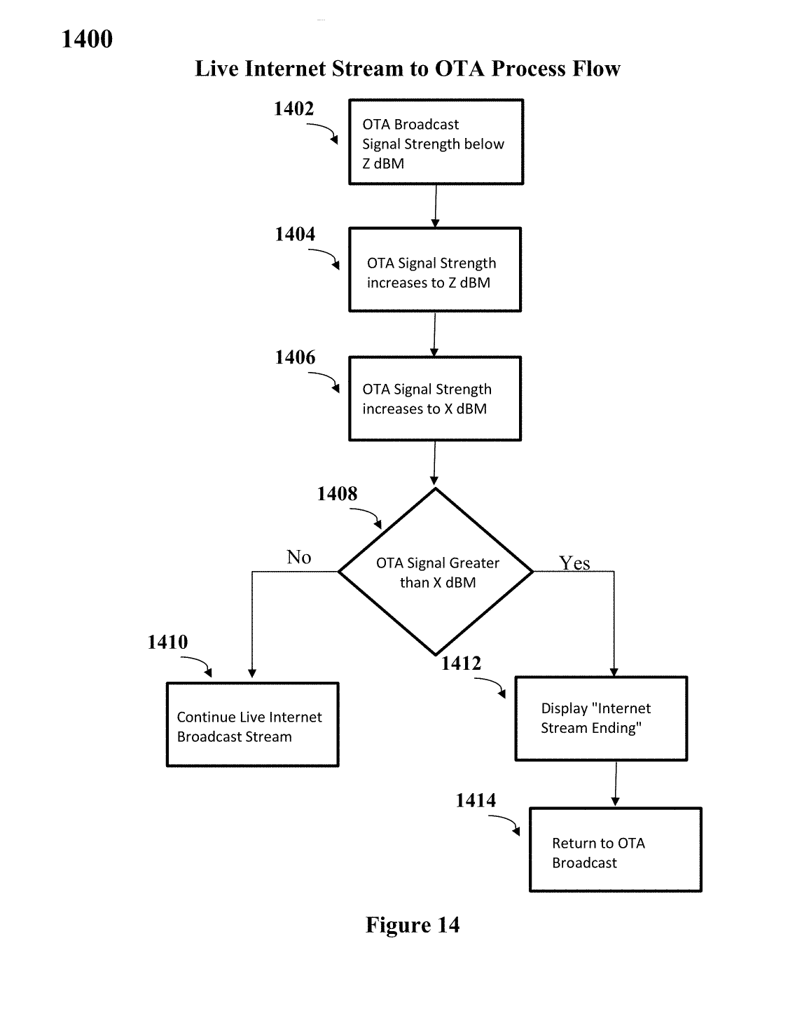

Referring now to FIG. 14, a methodology 1400 that facilitates an internet stream to OTA transition is illustrated. The methodology 1400 begins at 1402, where the strength of signal is at Z dBM level 1206, below X dBM level 1204, the OTA radio transmission goes on standby (still reading signal strength). The methodology transitions to 1404 when the strength of signal increases to the X dBm level 1204. The methodology transitions to 1408 when the signal strength exceeds X dBm level 1204. As the strength of signal transitions, above the X dBm level 1204, the methodology transitions to 1410 and the internet stream continues. As the strength of signal is greater than the X dBm level 1204, the methodology transitions to 1412 where the display will silently notify the user “Internet Stream Ending”. The methodology then transitions to 1414 where the internet stream will end and the OTA transmission will resume.

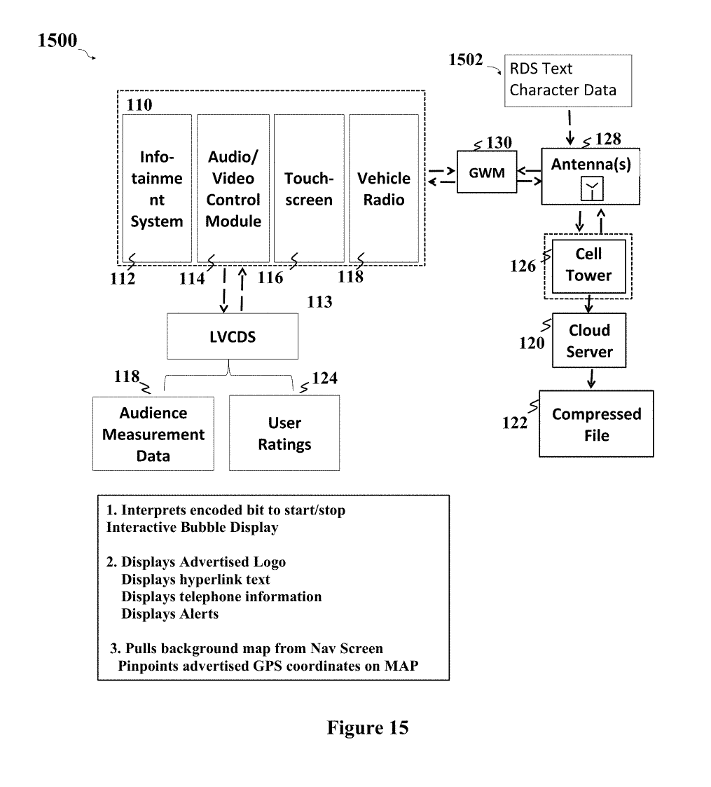

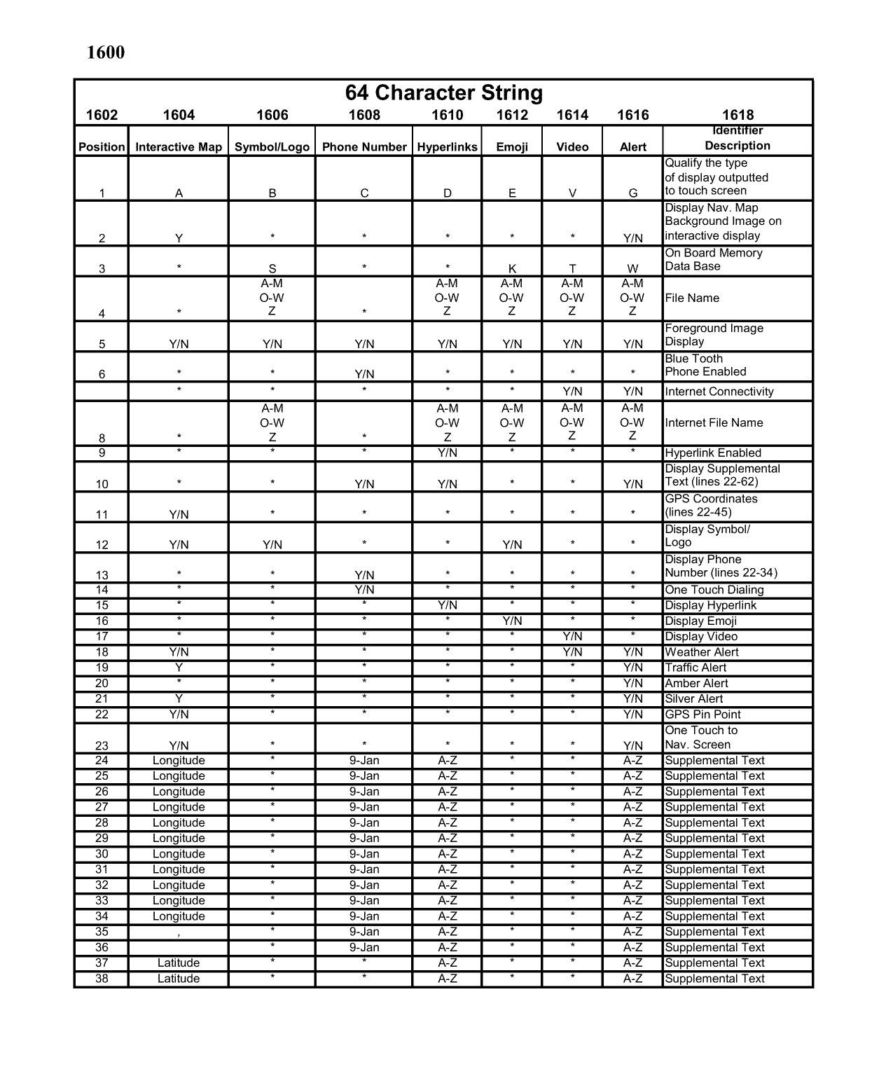

Referring now to FIG. 15, a functional block diagram of an exemplary system 1500 that facilitates the Interactive Bubble Advertising feature is illustrated. The Interactive Bubble Advertising system 1500 translates an OTA RDS RT data 1502 through software downloaded on the Infotainment System Module 112, the Audio/Video Control Module 114, touchscreen 116 or vehicle radio 117 for the purposes of outputting interactive advertisements. The Interactive Bubble Advertising system 1500 transmits the OTA RDS RT data 1502 to the antenna 128. The antenna 128 transmits the OTA RDS RT data 1502 to the Cell Tower 126. The Cell Tower 126 then transmits the OTA RDS RT data 1502 to the internet 120. The antenna 128 also transmits the OTA RDS RT data 1502 to the Gateway Module 130.

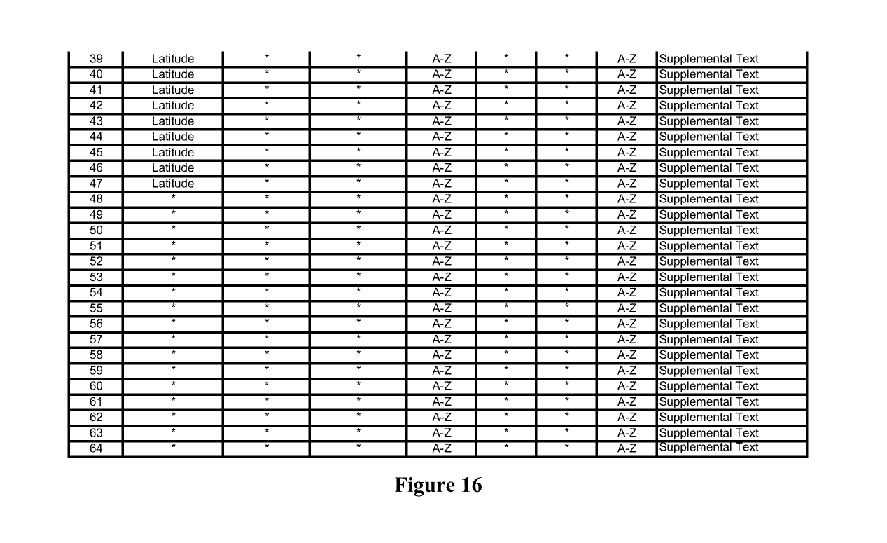

Referring now to FIG. 16, a table 1600 that facilitates use of an RDS RT for the Interactive Bubble Advertising system 1500 is illustrated. The RDS RT data 1502 sent from the OTA transmissions are encrypted in a sequential structure, then translated from the pre-loaded software, whereby the receiving device displays the translated OTA transmitted advertisement. Encrypted RDS RT are formatted in the table 1600, where each text character executes a protocol, based on its position in the string of text. The Interactive Bubble Advertising system 1500, coupled with software in the Infotainment System Module 112, the Audio/Video Control Module 114, touchscreen 116 or vehicle radio 117 uses the first position of the RDS RT 1502 to qualify the type of display as identified in an Identifier Description 1618.

Remaining on FIG. 16, random single character variables are used in Position 1602 with a value of 1 as A, B, C, D, E, V and G. Translated with the pre-loaded software, the RDS RT data 1502 defines the details of the advertisement. The Identifier Description 1618 qualifies the advertised display within the bounds of the Interactive map 1604, the symbol/logo 1606, the phone number 1608, the hyperlink 1610, the emoji 1612, the video 1614, the alert 1616. Universal Variables, ‘Y’, ‘N’ and ‘*’, used in correlation to the Identifier Description 1618 to execute the software's protocol. ‘Y’ denotes Yes, ‘N’ denotes No and ‘*’ denotes not applicable to the Identifier Description 1618.

Remaining on FIG. 16, the Position 1602 with a value of 2 displays the vehicle's Navigation Map in the background of the space allotted on the display and is denoted with the universal variable ‘Y’. The RDS RT data 1502 for a non-map image will be the unique universal identifier ‘*’, denoting no action to be taken or no image to be displayed in the background of the allotted advertising display space.

Remaining on FIG. 16, the Position 1602 with a value of 3 executes a command to pull-up a unique database, housed inside the memory of the Infotainment System Module 112, the Audio/Video Control Module 114, on-board vehicle touchscreen 116 or vehicle radio 117. The database is identified with the variables ‘S’ for Symbol/Logo database, ‘K’ for Hyperlinks, ‘T’ for Video and ‘W’ for Alert.

Remaining on FIG. 16, the Position 1602 with a value of 4 pulls up a unique file from the database selected in Position 3 for the Symbol/Logo 1606, the Hyperlinks 1610, the Emoji 1612, the Video 1614, or the Alert 1616. Pre-loaded software translates the file name and calls-up the desired advertisement files.

Remaining on FIG. 16, the Position 1602 with a value of 5 pulls up a Foreground Image. The database is identified with a simple universal qualifier ‘Y’ or ‘N’, indicating if the Interactive Bubble Advertisement is to be displayed in the foreground.

Remaining on FIG. 16, the Position 1602 with a value of 6 enables a Blue Tooth Phone to temporarily pair a vehicle's already connected phone to allow single touch screen dialing of the telephone number displayed on the advertisement. A Universal qualifier ‘Y’ or ‘N’ is to be the text character qualifier indicating to the pre-loaded software to recognize the telephone number as compatible with single touch dialing.

Remaining on FIG. 16, the Position 1602 with a value of 7 looks for the Universal qualifier ‘Y’ or ‘N’ to determine if the internet is connected and available for two way communication from the Infotainment System Module 112, the Audio/Video Control Module 114, on-board vehicle touchscreen 116 or vehicle radio 117. ‘Y’ signals to the software that a direct link to the internet database server is to be established.

Remaining on FIG. 16, the Position 1602 with a value of 8 looks for an internet file name identified by any text character that houses those selected files containing the Symbol/Logo 1606, the Hyperlinks 1610, the Emoji 1612, the Video 1614, or the Alert 1616 advertisements.

Remaining on FIG. 16, the Position 1602 with a value of 9 uses the simple universal qualifier ‘Y’ or ‘N’ to flag the pre-loaded software that a Hyperlink to be transmitted to the Infotainment System Module 112, the Audio/Video Control Module 114, on-board vehicle touchscreen 116 or vehicle radio 117.

Remaining on FIG. 16, the Position 1602 with a value of 10 uses the universal qualifier ‘Y’ or ‘N’ to flag the pre-loaded software that the Phone Number 1608, the Hyperlink 1610, or the Alert 1616 displays the Supplemental Text Characters from RDS Text Character Position 24-64.

Remaining on FIG. 16, the Position 1602 with a value of 18 uses the universal qualifier ‘Y’ or ‘N’ to flag the pre-loaded software to recognize the Supplemental Text Characters from RDS Text Character Position 24-64 as an Alert Message. Weather Alert can also be an overlay of the Navigation Map, equipped on the vehicle, and overlay the map with Doppler radar. Weather Alert can also flag live OTA broadcast video transmissions to break-in to the current broadcast.

Remaining on FIG. 16, the Position 1602 with a value of 19 uses the universal qualifier ‘Y’ or ‘N’ to flag the pre-loaded software to recognize the Supplemental Text Characters from RDS Text Character Position 24-64 as an Alert Message. Traffic Alert can also be an overlay of the Navigation Map, equipped on the vehicle, and overlay the heavy traffic areas.

Remaining on FIG. 16, the Position 1602 with a value of 20 uses the universal qualifier ‘Y’ or ‘N’ to flag the pre-loaded software to recognize the Supplemental Text Characters from RDS Text Character Position 24-64 as an Amber Alert Message.

Remaining on FIG. 16, the Position 1602 with a value of 21 uses the universal qualifier ‘Y’ or ‘N’ to flag the pre-loaded software to recognize the Supplemental Text Characters from RDS Text Character Position 24-64 as a Silver Alert Message.

Remaining on FIG. 16, the Position 1602 with a value of 22 uses the universal qualifier ‘Y’ or ‘N’ to flag the pre-loaded software to recognize the GPS coordinates, as broadcast in Positions 24-36, as a pinpoint on the map.

Remaining on FIG. 16, the Position 1602 with a value of 23 uses a touch of the map to become a destination for the map to provide route guidance.

Remaining on FIG. 16, the Position 1602 with a value of Position 24-64 uses various Text Characters for the purposes of providing Longitude and Latitude coordinates for the interactive map, numbers to display the advertised phone number and any series of text characters for the Hyperlink 1610 or the Alert 1616.

Referring back to FIG. 15, the system 1500 qualifies the advertised display within the bounds of the Interactive map 1604, the symbol/logo 1606, the phone number 1608, the hyperlink 1610, the emoji 1612, the video 1614, the alert 1616. The Gateway Module 130 then transmits the OTA RDS RT data 1502 to the LVDCS software 113, where the LVDCS software 113 interprets the encoded bit to start and stop the Interactive Bubble display. In one exemplary embodiment, the LVDCS software 113 displays an advertised logo. In another exemplary embodiment, the LVDCS software 113 displays a hyperlink text. In another exemplary embodiment, the LVDCS software 113 displays a telephone dial information. In another exemplary embodiment, the LVDCS software 113 displays alerts. In another exemplary embodiment, the LVDCS software 113 pulls a background map from the navigation screen and pinpoints advertised GPS coordinates on the background map.

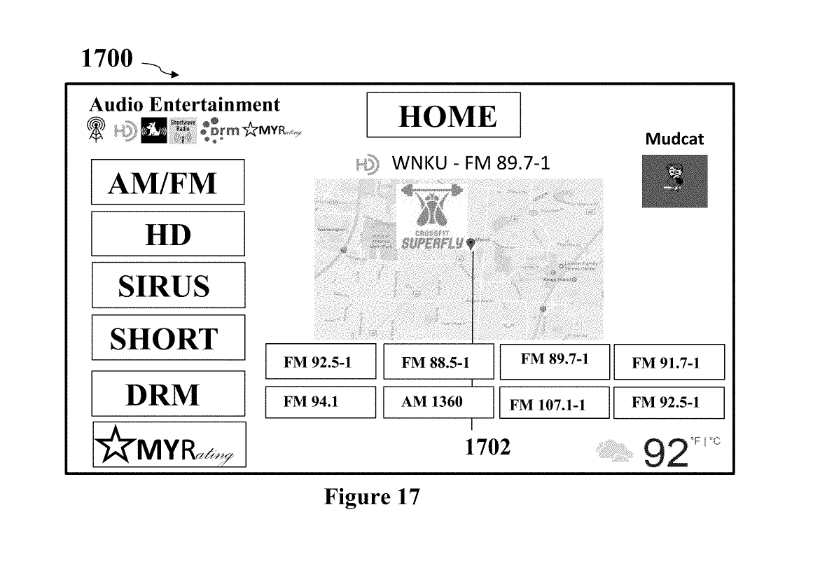

Referring now to FIG. 17, a mock-up 1700 of the Interactive Bubble Advertising system displaying advertised location is shown. The Position 1602 with a value of 11 Identifier Description GPS Coordinates uses the universal qualifier ‘Y’ or ‘N’ to flag the pre-loaded software to recognize the Supplemental Text Characters from the RDS RT data 1502 Position 24-47 as GPS coordinates. Coupled with other protocols from other Position's, the Interactive Bubble Advertising system is capable of pinpointing the advertised location on the Navigation screen 1702, allowing the occupant to touch the logo or pinpoint for direct route navigation to the advertised location.

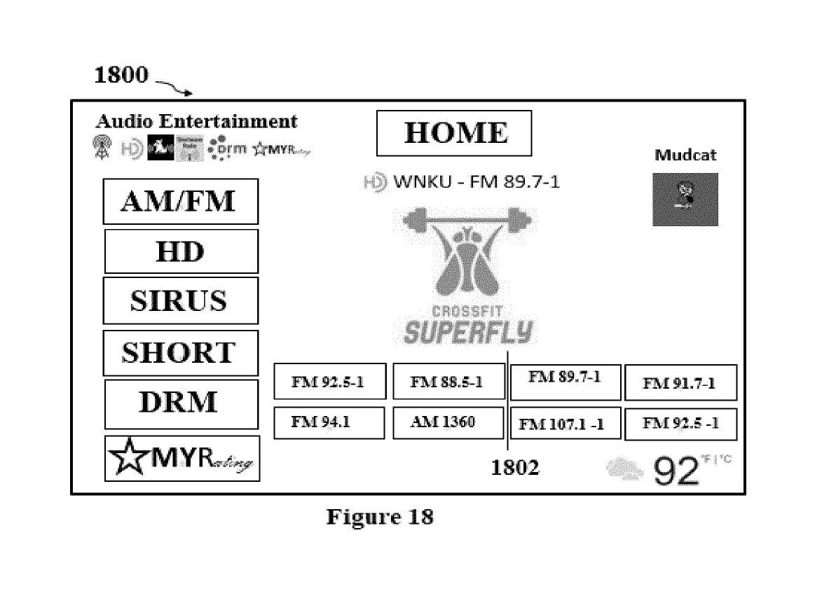

Referring now to FIG. 18, a mockup 1800 of the Interactive Bubble Advertising system displaying a Symbol or Logo 1802 on the Infotainment System Module 112, the Audio/Video Control Module 114, onboard vehicle touchscreen 116, or vehicle radio 117 is illustrated. The Position 1602 with a value of 12 Identifier Description Display Symbol/Logo uses the universal qualifier ‘Y’ or ‘N’ to flag the pre-loaded software to display a Symbol or Logo 1802, chosen from a database file location identified in Position 4 or 8.

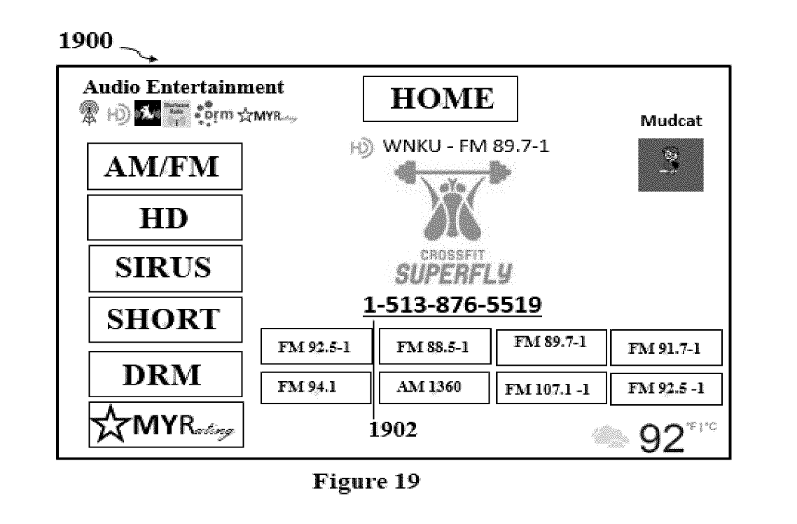

Referring now to FIG. 19, a mockup 1900 of the Interactive Bubble Advertising system displaying and capable of single touch dialing the advertised phone number 1902 appearing on Infotainment System Module 112, the Audio/Video Control Module 114, onboard vehicle touchscreen 116, or vehicle radio 117 is illustrated. The Position 1602 with a value of 13 Identifier Description Display Phone Number 1902 uses the universal qualifier ‘Y’ or ‘N’ to flag the pre-loaded software to recognize the Supplemental Text Characters from RDS RT data 1502 Position 24-36 as phone number digits. Position 14 Identifier Description One Touch Dialing uses the universal qualifier ‘Y’ or ‘N’ to instruct the pre-loaded software to link the phone number 1902 displayed from Supplemental Text lines 24-36 to that of the occupant's phone via the Blue Tooth connection. Coupled with prior protocols, the Interactive Bubble Advertising system is capable single touch dialing of the advertised phone number 1902 appearing on the Infotainment System Module 112, the Audio/Video Control Module 114, onboard vehicle touchscreen 116, or vehicle radio 117.

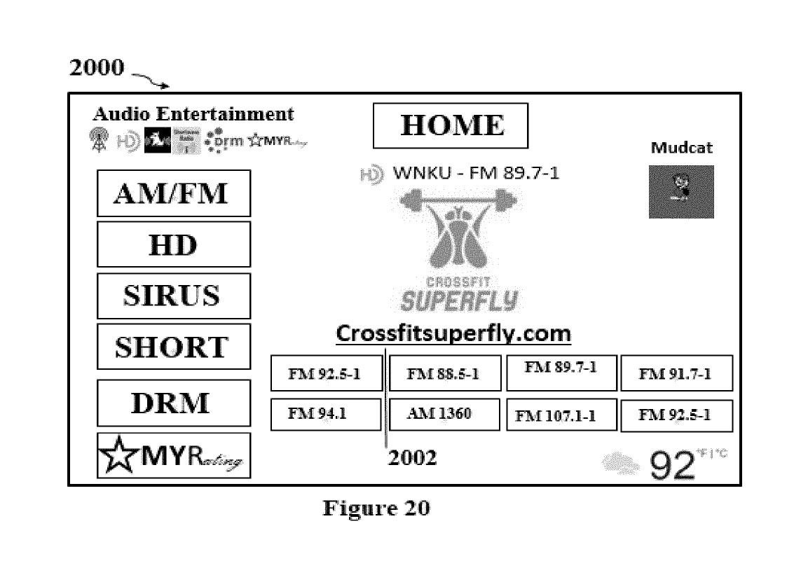

Referring now to FIG. 20, a mockup 2000 of the Interactive Bubble Advertising system displaying advertised content generated from a pre-defined URL 2002 is illustrated. The Position 1602 with a value of 15 Identifier Description Display Hyperlink uses the universal qualifier ‘Y’ or ‘N’ to instruct the pre-loaded software to translate Supplemental Text lines 24-64 into a web address that when coupled with Position 9. Hyperlink Enabled variable ‘Y’, underlines the text in the form of a web address. One touch or button press will lead the user to the desired advertised content.

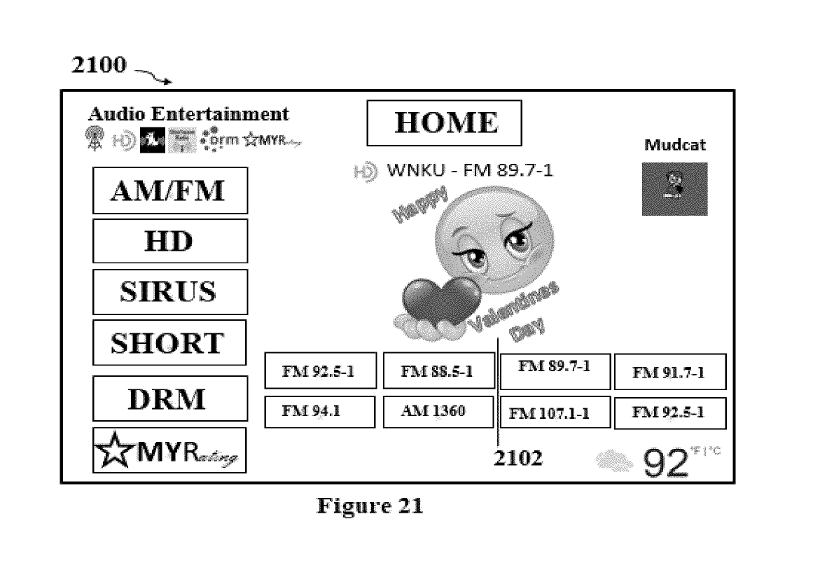

Referring now to FIG. 21, a mockup 2100 of the Interactive Bubble Advertising system displaying an emoji 2102 is illustrated. The Position 1602 with a value of 21 Identifier Description Display Emoji 2102 uses the universal qualifier ‘Y’ or ‘N’ to instruct the pre-loaded software to display the selected emoji as indicated from Position 4 or 8.

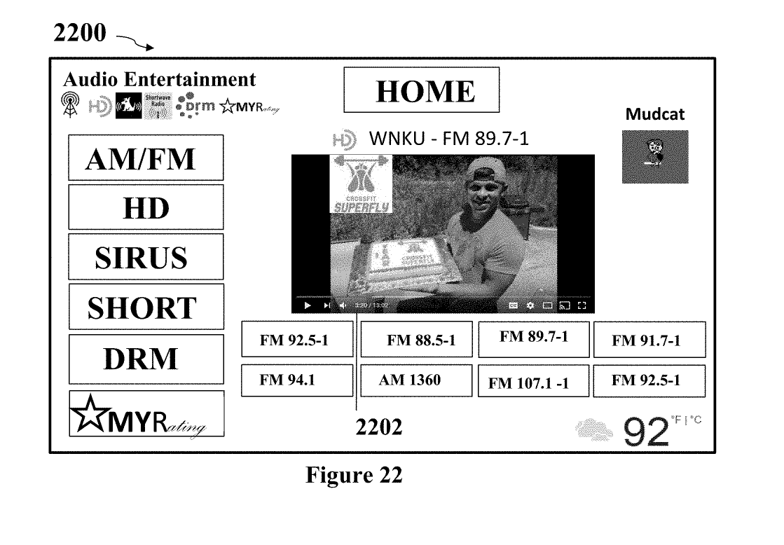

Referring now to FIG. 22, a mockup 2200 of the Interactive Bubble Advertising system displaying and capable of playing a video 2202 generated from a pre-defined URL is illustrated. The Position 1602 with a value of 17 Identifier Description Display Video 2202 uses the universal qualifier ‘Y’ or ‘N’ to instruct the pre-loaded software to play the selected video as indicated from Position 4 or 8.

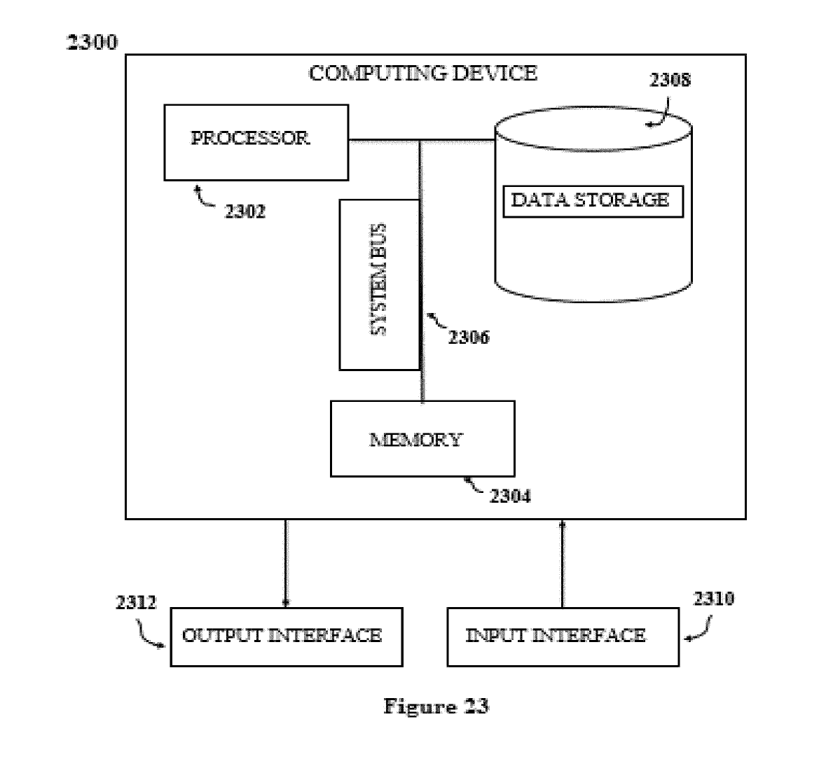

Referring now to FIG. 23, an illustration of an exemplary computing device 2300 that can be used in accordance with the systems and methodologies disclosed herein is illustrated. The computing device 2300 includes at least one processor 2302 that executes instructions that are stored in a memory 2304. The instructions may be, for instance, instructions for implementing functionality described as being carried out by one or more components discussed above or instructions for implementing one or more of the methods described above. The processor 2302 may access the memory 2304 by way of a system bus 2306. The computing device 2300 additionally includes a data storage 2308 that is accessible by the processor 2302 through the system bus 2306. The data storage 2308 may include executable instructions. The computing device 2300 also includes an input interface 2310 that allows external devices to communicate with the computing device 2300. For instance, the input interface 2310 may be used to receive instructions from an external computer device, from a user, etc. The computing device 2300 also includes an output interface 2312 that interfaces the computing device 2300 with one or more external devices. For example, the computing device 2300 may display text, images, etc. by way of the output interface 2312.

It is contemplated that the external devices that communicate with the computing device 2300 via the input interface 2310 and the output interface 2312 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 2300 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 2300 may be a distributed system. Thus, for instance, several devices may be in communication by way of a network connection and may collectively perform tasks described as being performed by the computing device 2300.

While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system, comprising:
a plurality of input signals;
an audio and video control module, the audio and video control module coupled to the plurality of input signals, the audio and video control module configured to receive a user input;
an infotainment system, the infotainment system module coupled to the audio and video control module, the infotainment system module configured to respond to the user input, the user input selecting from one of the plurality of input signals;
a gateway module, the gateway module coupled to the audio and video control module or the infotainment system module, the gateway module configured to receive a user data; and,
an antenna module, the antenna module coupled to the gateway module, the antenna module configured to transmit the user data to a cellular tower.

2. The system of claim 1, further comprising an audience measurement file and a cloud based server, the cloud based server receiving the user data from the audience measurement file.

3. The system of claim 1, further comprising a user rating software, the user rating software configured to transmit the user data to the cloud based server.

4. The system of claim 1, further comprising an OTA RDS Text Characters data, the OTA RDS Text Characters data configured to appear as an advertisement to the audio video control module.

5. A method of pairing an OTA transmission with its live streaming internet broadcast counterpart, the method comprising:
determining the strength of a set broadcast transmission for a relative geographical location, a series of conditions that compare a live signal strength reading to that of a preset numerical value, the preset numerical value corresponding to set signal conditions;
responsive to determining the strength of a set broadcast transmission, computing the signal strength of a station displayed on the audio and video control module or infotainment system; and,
responsive to computing the signal strength, evaluating the strength of a signal with variables set for initiating one of five operating modes, an Internet broadcast background start-up protocol mode, an Internet Stream Identified mode, an Internet broadcast begin mode, an Internet broadcast terminate mode, and a return to OTA transmission broadcast mode.

6. The method of claim 5, further comprising:
taking live readings of a station's signal strength measured in decibel-milliwatts (dBm);
responsive to taking live readings, executing one of the following protocols; A) Internet broadcast background start-up protocol; “Internet Stream Identified”, B) Internet broadcast begin, C) Internet broadcast terminate D) Return to OTA Transmission broadcast, all for the intended use of non-disrupted streaming media; and,
responsive to executing one of four distinct protocols, transitioning from OTA broadcasts to live streaming internet broadcasts based on live strength of signal measurements where pre-defined variable strength of signal measurements are used to trigger executable events.

7. The method of claim 5, wherein subsequent to interpreting the vehicle make, model, model year from the vehicle on-board configuration:
taking live readings of that station's signal strength measured in decibel-milliwatts (dBm);
responsive to taking live readings, executing one of four distinct protocols; A) Internet broadcast background start-up protocol; “Internet Stream Identified”, B) Internet broadcast begin, C) Internet broadcast terminate D) Return to OTA Transmission broadcast, all for the intended use of non-disrupted streaming media; and,
responsive to executing one of four distinct protocols, transitioning from live streaming broadcast to OTA broadcasts based on live strength of signal measurements where pre-defined variable strength of signal measurements are used to trigger executable events.

8. The method of claim 5, wherein creating a data subset from user inputted data, using a five star rating system for exclusive user content.

9. The method of claim 5, further comprising:
reading the OTA RDS Text Characters data broadcast from an Over-The-Air transmission; and,
responsive to reading the OTA RDS Text Characters data, translating the OTA RDS Text Characters data via a protocol into an onboard interactive advertisement for display to the audio and video control module.

10. The method of claim 5, further comprising:
transmitting the OTA RDS Text Characters data to an antenna;
responsive to transmitting the OTA RDS Text Characters data to the antenna, transmitting the OTA RDS Text Characters data to a cell tower; and,
responsive to transmitting the OTA RDS Text Characters data to a cell tower, transmitting the OTA RDS Text Characters data to an internet and to the gateway module.

11. The method of claim 5, wherein obtaining the user data.

12. The method of claim 5, wherein viewing, sorting, organizing, filtering, and graphing the user data.

13. A system comprising:
a processing unit;
a memory;
instructions in the memory, that, when executed by the processing unit, perform the following acts:
storing user profile data including user first name, last name, e-mail, telephone number and age;
reading an input signal from an Infotainment System Module, Audio and Video Control Module, touchscreen or vehicle radio;
responsive to reading an input signal, interpreting audio or video received, including signal strength of transmission and GPS location; and,
responsive to interpreting audio or video received, interpreting vehicle make, model, model year from the vehicle on-board configuration.
